(19) United States
(12) Patent Application Publication
(10) Pub. No.: US 2007/0235084 A1
(43) Pub. Date: Oct. 11, 2007

(54) Leak compensating valve with flow switch indicator

(76) Inventor: Yong C. Kim, Glendale, CA (US)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/715,855

(22) Filed: Mar. 8, 2007

Related U.S. Application Data
(60) Provisional application No. 60/790,134, filed on Apr. 7, 2006.

(51) Int. Cl. F16K 15/20

(52) U.S. Cl. 137/224

(57) ABSTRACT

A valve (10) for use on a large truck with a tire inflation system, flows air into a leaking tire and energizes a light to indicate the presence of a leak to the driver. The valve has a passage (22) that connects a high pressure inlet (14) to an outlet (16) that connects to the tire. The passage has a blockable part (24) extending in forward-rearward (F, R) longitudinal directions, and the valve has a piston (26) with a front end (30) that slides in the blockable passage part and that is biased forwardly by a spring (36). The spring lies in a spring chamber (40) extending rearward of the blockable passage part. An electric switch (50) senses rearward piston movement to energize a warning light (62) in the vehicle cab. In one valve, the passage blockable part has a tapered rear end (24R) to rapidly increase air flow as the piston begins to allow air flow. In another valve, a passage connection section (272) is provided that intersects the blockable passage part (276) and connects to an outlet passage portion (284).

### BACKGROUND OF THE INVENTION

Large trucks (e.g. over 5 tons empty weight) generally have a source of pressured gas such as air at 100 psi that is used to operate equipment such as air brakes, air bags, and horns, and that is sometimes used to keep the truck tires properly filled with air. It is well known that the pressure of air in vehicle tires should be maintained at the pressure recommended by the manufacturer, especially in the case of radial tires, to avoid dangerous vehicle handling and to maintain long tire life. Inflation systems are being provided in large vehicles that use the vehicle pressured air source to keep the tires inflated at the proper pressure. If a tire begins to leak air, as when a nail has punctured the tire (but the nail still lies in the tire and allows only a small rate of leakage), the inflation system allows pressured air to flow to the tire to maintain its proper pressure. This avoids the need for the truck to stop and for the tire to be replaced by a new one on the road. However, the constant flow of air to the tire results in wasting pressured air, and therefore wasting of energy used in generating more pressured air, and the tire becomes further damaged as the vehicle travels with it. The inflation systems also can be used to inflate other truck equipment such as air bags.

### SUMMARY OF THE INVENTION

In accordance with one embodiment of the present invention, a vehicle flow control valve is provided that flows air to a valve outlet to maintain the outlet air pressure at a predetermined difference from an inlet air pressure, and that warns the driver when there is an air flow to the outlet. The valve is especially useful to maintain a constant vehicle tire pressure despite a tire leak, and to warn the driver of the leak. The valve has a housing with a passage that extends from the inlet to the outlet, and that has a passage blockable part that extends in front-rear longitudinal directions. A piston has a front piston part that lies in the blockable passage part to initially prevent the flow of air to the outlet. A spring chamber lies rearward of the blockable passage part and holds a spring that forwardly biases the piston. The chamber is connected to the outlet and applies the outlet pressure to the rear of the piston to bias it forwardly. An electric switch has an actuator in the path of the piston to generate a warning light when the piston moves rearward of its initial portion, as to indicate a tire leak.

In one flow control valve, the blockable passage part has a tapered rear end. When the front end of the piston has moved rearward so far that it lies in the tapered rear end of the passage part, the flow can increase exponentially with further piston movement, which is especially useful when a tire is to be initially inflated. To avoid intermittent audible “buzzing and fluttering” sounds, another embodiment of the invention includes a connecting passage section that has one end opening to the blockable passage part and another end opening to an outlet passage portion that extends to the outlet. Substantially all flow from the inlet to the outlet passes through the connecting passage section. A lateral passage can be drilled or bored by providing a recess that is usually closed, and that is connected to the spring chamber, passing a drill or boring tool through the recess to form the hole, and closing the recess with a cover.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a simplified sectional view of a flow control valve of the present invention, with the piston in an initial closed position.

FIG. 2 is an enlarged sectional view of a portion of the valve of FIG. 1 with the piston in its initial position and with the electric switch in an inactivated position.

FIG. 3 is a view similar to that of FIG. 1, but with the piston moved rearward to an open position and the switch and an activator in an activated position.

FIG. 4 is an isometric view of the valve of FIG. 1, but with a cover of the type present in the valve of FIG. 7.

FIG. 5 is an enlarged partial sectional view of a valve of another embodiment of the invention.

FIG. 6 is a partial isometric view of a portion of the valve of FIG. 5.

FIG. 7 is a sectional view of a control valve of another embodiment of the invention, wherein a covered recess is left to facilitate drilling and/or boring of a laterally-extending passage part.

FIG. 8 is a sectional view of another embodiment of the invention, which is similar to that of FIG. 7, but wherein a drilled and\or bored hole does not have to have its end blocked.

FIG. 9 is a sectional view of another embodiment of the invention which is similar to that of FIG. 8, except that a connecting passage section is provided to avoid annoying sounds.

### DESCRIPTION OF THE PREFERRED EMBODIMENTS

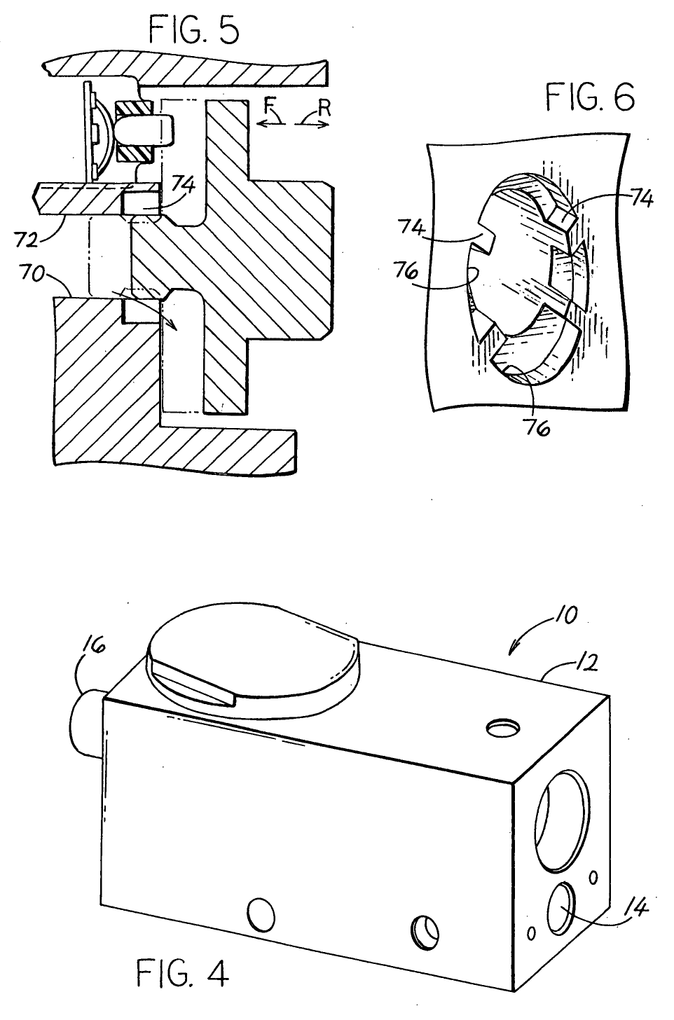

FIG. 4 is a view of the outside of a vehicle flow control valve apparatus 10 of the invention, which also serves as a flow indicator. The valve apparatus, or valve 10 has a housing 12 with an inlet 14 that is connected to a pressured air source, such as a source at 100 psi., that is used for tire inflation and to power air brakes and an air horn. The valve has an outlet 16 that delivers air to equipment such as a tire to keep the tire fully inflated even if there is a tire leak.

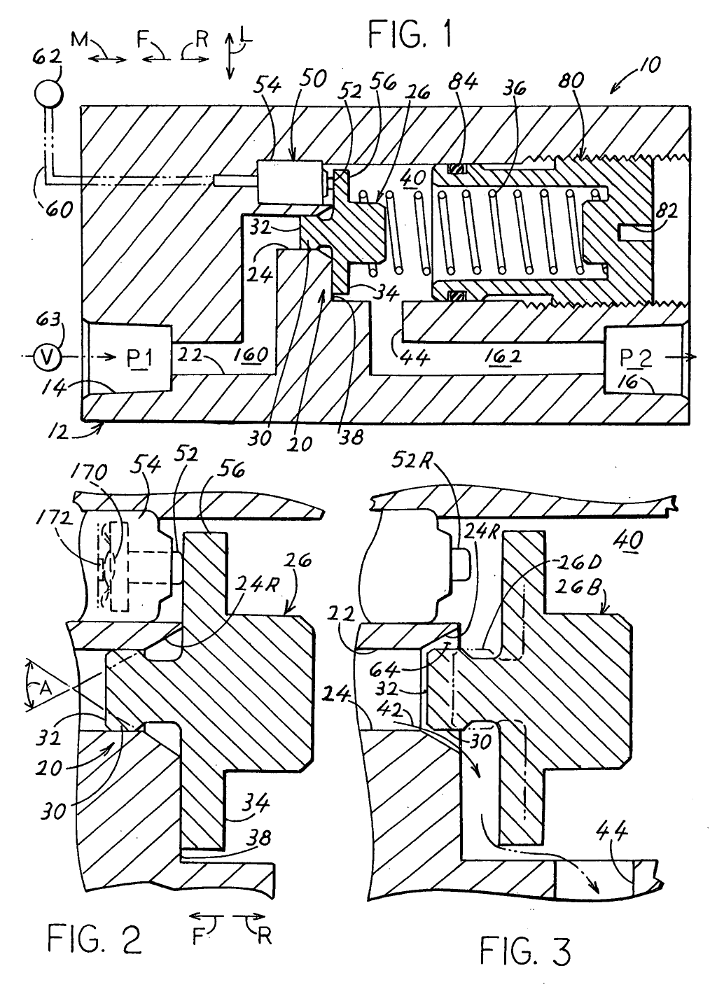

FIG. 1 shows that the valve has a passage 22 with a front or inlet passage portion 160 that extends from the inlet 14, and with a rear or outlet passage portion 162 that extends to the outlet 16. The front passage portion includes a blockable passage part 24. The valve includes a piston 26 that is slidable in forward F and rearward R longitudinal direction M. The piston has a front end 30 forming a blocking portion that initially lies in the blockable passage part 24, in a close fit therein. The close fit (no more than 0.001 inch clearance between the piston front end and the walls of the blockable passage part) assures that there is no appreciable air flow around the piston in the initial blocking position of FIGS. 1 and 2.

As also shown in FIG. 2, the pressure of air supplied to the inlet presses rearwardly R against a front face 32 of the piston, to urge the piston rearward. At the same time, the pressure of air in the tire that is connected to the outlet presses against the rear face 34 of the piston to urge the piston forward. A spring 36, shown in FIG. 1, urges the piston forward with a force equivalent of 3 psi, that is, with a force that would be applied by a pressure difference such as 3 psi. across the piston faces. As a result, with an inlet pressure P1 of 100 psi, when the air pressure P2 against the piston front end 34 is at least 97 psi, the piston remains in its initial position illustrated in FIGS. 1 and 2 wherein the piston abuts a housing wall 38 and blocks the flow of air to the outlet 16. The outlet 16 is connected to a closed spring chamber 40 in the housing, that holds the spring 36. If air leaks out of a tire that is connected to the outlet 16, then air pressure in the chamber 40 will decrease as tire pressure decreases.

If the tire connected to the outlet 16 leaks, then the tire pressure will begin to fall below the level of 97 psi at which the valve 10 opens. Then, the piston 26 will begin to move rearward R with further decreasing tire air pressure until the piston reaches the open position shown at 26B in FIG. 3. The passage blockable part 24 that the piston slides in, includes a passage rear end 24R of greater diameter than a more forward region of the blockable passage part. When the piston reaches the position 26B, air can flow around the piston front end 30 into the spring chamber 40, and out through a chamber-connected hole 44 and the rear passage portion 162 to the outlet 16 to refill the tire. Applicant notes that the piston will not begin to move rearward from its initial position until the tire pressure drops slightly below 97 psi to overcome friction of the piston against the walls of the passage, and the piston will not reach the open position until there has been an additional pressure drop (which may be a fraction of one psi.) to compress the spring by the distance of piston travel to reach the open position at 26B. Once air begins to flow towards the tire, as indicated by arrow 42, the tire pressure will likely increase or not drop further. The piston may move forward F slightly until the valve closes.

The initial tire air pressure may be 100 psi, and the purpose of the valve is to prevent tire air pressure from dropping below 97 psi by repeatedly or continuously refilling the tire, and to generate a warning to indicate that the tire pressure has dropped more than 3 psi from its original pressure. A warning is generated by a warning switch 50 (FIG. 1) that has a switch activator 52 lying in the path of the piston. When the piston remains in its initial position 26, the switch activator remains in its original position 52 wherein it remains pushed forward F into the switch housing 54 by a piston part 56. When the piston reaches the open position 26B of FIG. 3, the switch activator moves rearward R to its rearward position 52R. As the switch activator moves rearward (under the force of an internal spring force such as by a dome) and approaches its rearward position 52R shown in FIG. 3, the warning switch is activated and generates a signal that passes through conductors 60 that cause activation of a warning indicator such as energization of a warning light 62. The warning light 62 can be seen by the driver, as where it lies in the dashboard. The driver may then drive the vehicle into the next repair station that he reaches along his trip, where the tire is checked for a leak and repaired or replaced if a leak is found. A valve 63 blocks the flow of air to the inlet of the valve when a tire is being changed.

The particular warning switch illustrated is a dome switch with a dome 170 (FIG. 2) having a center that is initially deformed against a contact 172 to close a circuit. When the piston moves rearward and allows the switch activator 52 to move rearward, the dome returns to an undeformed state and breaks engagement with the contact 172 to cause circuitry to energize the warning light 62 (FIG. 1).

Most tire leaks are slow leaks, so the pressured air source on the vehicle can provide sufficient air to maintain tire pressure despite the leak. It is important to maintain close to the predetermined tire pressure to assure safety and to minimize tire wear. Maintaining a constant or repeated air flow into a leaking tire requires extra energy to compress the air, which increases the use of fuel. Also, small leaks often become larger and should be repaired soon after they are discovered. By providing a warning to the driver when a leak occurs, applicant allows the driver to repair the leak as soon as possible.

If the tire is repaired or replaced, the repaired or replacement tire will usually have an initial air pressure close to zero. The same system can be used to fill the tire with air by opening the valve 63 that prevented air flow when the tire was removed. Air then flows through the valve to refill the tire. To refill an initially empty tire in a moderate amount of time (e.g. 100 seconds), there must be a high flow rate of air through the blockable passage part rear end 24R around the piston. Applicant constructs the blockable passage part rear end so it is tapered to have a greater cross-section at a more rearward location. As a result, the piston can move further rearward, as to position 26D (FIG. 3) wherein the space 64 around the piston front end is large enough to rapidly fill the tire. The tapered blockable passage part rear end 24R is also useful to guide the piston front end 30 forward into the blockable passage part 24.

FIGS. 5 and 6 show another way to guide the piston front end in a blockable passage part 70 of a passage 72. FIG. 6 shows that the housing forms a plurality of guides 74 that guide the piston, and the housing forms large spaces, or cutouts 76 between the guides for the flow of air around the piston.

In FIG. 1, the valve 10 includes an adjustment screw 80 that can be used to adjust the spring force on the piston 26. A screwdriver blade can be inserted into a slot 82 and the adjustment screw can be turned to advance it forward or rearward. It is possible to turn the adjustment screw to advance it rearward R to reduce the spring force to nearly zero, during initial filling of a tire, so the tire pressure rises to 100 psi. The adjustment screw is then turned to advance it forward F until it applies a predetermined force that keeps the valve closed until the tire pressure falls below 97 psi. Markings can be provided to indicate the two adjustment screw positions, and a stop can be used to prevent the adjustment screw from being advanced rearwardly so far that it is removed. An O-ring 84 prevents leakage past the adjustment screw.

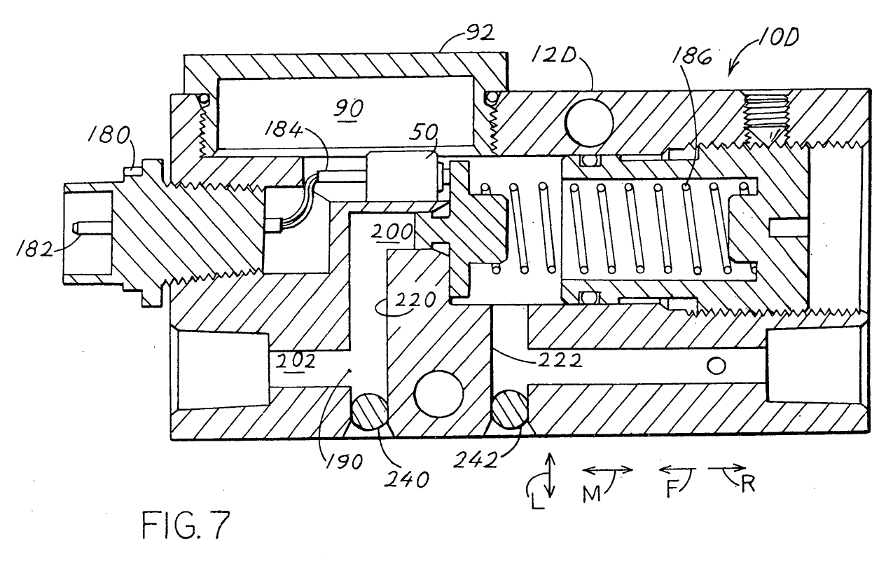

As mentioned above, FIG. 1 is a simplified sectional view of a valve that includes a flow indicator. FIG. 7 is a more detailed sectional view of the valve 10D. The valve includes a recess 90 with a sealed cover 92 for access to the warning switch 50. The indicator also includes an electrical connector 180 with a pair of contacts 182 connected to contacts 184 of the warning switch. The inlet passage portion 190 includes laterally L offset upper and lower parts 200, 202. The flow indicator housing 12D includes a block of steel with vertical holes 220, 222 drilled (or bored) into the bottom of the block and horizontal holes drilled into the block to connect to the vertical holes. The lower ends of the vertical holes are closed by blocks 240, 242.

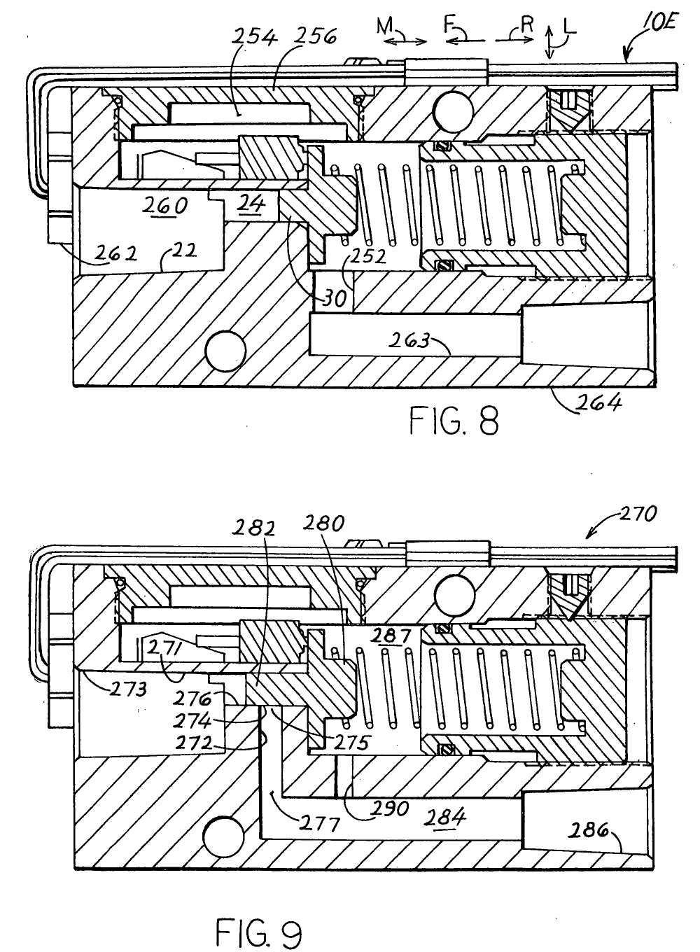

FIG. 8 illustrates another valve 10E wherein vertical holes are not closed by blocks. Only one vertical hole 252 is drilled or bored, and it is formed by a hole started in a recess, or empty space, 254 when a cover 256 is removed. The passage inlet end 260 is offset from the electrical connector 262. The electrical connector can have a single conductor, with the housing 264 forming an electrical ground and one electrical wire connected to the housing.

In a flow indicator that applicant has constructed of the type illustrated in FIGS. 1 and 7, the blockable passage part 24 and the piston front end 30 were precision ground to a diameter of 0.189 inch±0.0004 inch, with the clearance between it and the passage no more than 0.001 inch. The angle A (FIG. 2) of the passage rear enlarged portion 24R was 60°

Applicant built and tested valves of the construction shown in FIG. 8. One problem that was encountered was that during normal valve operation at various inlet pressures, the valve generated intermittent audible and annoying “buzzing and fluttering” sounds. Such sounds were traced to irregular and turbulent actions near the vertical hole 252 that connects the chamber to the rear passage portion 262, and is also believed due to vibrations of the piston front end 30. Such sounds could indicate that a part is undergoing vibrations that could lead to fatigue failure. FIG. 9 illustrates a valve 270 that applicant designed which eliminates such annoying noise. The valve includes an inlet passage portion 271 that includes an inlet 273 and a blockable passage part 276. The passage also includes a connecting section 272 with an upstream end 275 that connects to a location 274 lying at the intersection of the connecting section and the blockable passage part 276, and with a downstream end 277 that connects to the outlet passage portion 284. In addition, the piston 280 is provided with a further forwardly extending front end 282 that blocks the flow of air into the connection section 272 in the initial position of the piston.

When the piston of FIG. 9 moves rearward of its initial position until it allows air to flow through the passage connection section 272, air flows through the connection section and the outlet passage portion 284 to the outlet 286. Normally, such flow will increase tire pressure, with the pressure communicated to the chamber 286 through a hole 290, to move the piston forward towards its initial position. Applicant has built and tested several valves of the construction shown in FIG. 9 and found that the annoying sounds were not present in any of the valves.

Thus, the invention provides a valve apparatus or valve that flows pressured air from a high pressure source to a vehicle part such as a tire, to maintain a predetermined tire pressure such as 3 psi below the source pressure, and which provides an indication to the driver when there is a leak in the part that receives the pressured air. The valve includes a passage with front and rear, or upstream and downstream, passage portions connected, respectively to a valve inlet and a valve outlet. A spring-biased piston has a front end that lies in a blockable passage part of the front passage portion. A spring chamber that holds the spring, lies rearward of the piston front end and is connected to the rear passage portion so the chamber pressure is always equal to the outlet pressure. When the tire pressure drops as a result of a tire leak, and the piston moves rearward to allow air to flow to the outlet, such piston movement is sensed by an electrical switch that energizes a warning light or the like that can be seen by the vehicle driver. In one valve, air that flows past the piston front end when the piston moves rearward, flows through the chamber and through the hole that connects the chamber to the rear passage portion. In another valve, the air that flows past the piston front end, flows through a connecting section of the passage, that connects the blockable passage part to the rear passage portion.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A vehicle control valve for a vehicle with a cab, which flows pressured air that is received at a valve inlet of a valve housing, to a valve outlet of the housing to maintain the valve outlet at a predetermined pressure below the inlet pressure, comprising:
a passage that extends within said housing between said valve inlet and said valve outlet, said passage including an inlet passage portion connected to said inlet and an outlet passage portion connected to said outlet, said inlet passage portion including a blockable passage part;
a piston that has a forward piston end that lies in said blockable passage part and blocks it, said piston being moveable rearward along a piston path away from an initial piston position and then forward to its initial position, said housing having a spring chamber extending rearward from said blockable passage part and rearward of said piston, said passage including a chamber hole that connects said spring chamber to said outlet passage portion;
a spring lying in said spring chamber and pressing said piston forwardly, in addition to force applied by air pressure in said chamber, so a low pressure in said outlet and in said chamber results in the piston front end moving rearward to a position in said blockable passage part where pressured air can flow past the piston front end to flow into said outlet passage portion;
said valve flow control including an electrical switch with an actuator lying in the path of movement of said piston to operate the switch when the piston moves rearward from said initial piston position, and an indicator viewable by a driver in said cab which is energized by operation of said switch.

2. The control valve described in claim 1 wherein:
said blockable passage part has an enlarged rear end that allows pressured air to flow around said piston front end into said spring chamber and then through said chamber hole toward said outlet, when the forward piston end has moved sufficiently rearward.

3. The control valve described in claim 2 wherein:
said blockable passage part end is tapered in diameter with a front end of smallest diameter.

4. The vehicle flow control valve described in claim 2 wherein:
said forward blockable part of said piston-receiving passage portion is part of a cylinder and said passage rear part has an axis, and said housing has a plurality of guides that are continuations of said cylinder and that are circumferentially spaced about said axis, and with cutouts of greater diameter than said cylinder lying between said guides.

5. The vehicle flow control valve described in claim 1, including:
housing walls forming a passage connection section having a downstream end connected to said outlet passage portion and having an upstream end connected directly to said blockable passage part at a location therealong that is rearward of a front face of said piston front end in the initial position of said piston front end, so air can flow through said passage connection section to said outlet passage portion only when said piston front end has moved far enough rearward to uncover said passage connection section upstream end;
said piston front end being long enough that when said piston front end first uncovers said passage connection section upstream end said piston front end has not allowed the flow of air from a rear end of said passage blockable portion into said chamber.

6. The control valve described in claim 1 wherein:
said chamber hole has a first end connected to said chamber and said chamber hole extends in a first lateral direction from said spring chamber, and said outlet passage portion extends rearward from a second end of said chamber hole;
said housing has a recess lying in a second lateral direction from said chamber and has a cover that covers said recess to prevent air leakage thereat;
said chamber hole is aligned with said space, to thereby facilitate drilling/boring said chamber hole.

7. A vehicle flow control valve which flows pressured air received at an inlet of a valve housing, to an outlet of the housing, to maintain the pressure at the outlet at a predetermined pressure below the inlet pressure, comprising:
a passage that extends within said housing between said valve inlet and said valve outlet, said passage including an inlet passage portion that extends from said inlet and that has a blockable passage part that extends in forward and rearward longitudinal directions, and a spring chamber that extends rearward of said blockable passage part, said passage also including an outlet passage portion that extends to said outlet;
a piston with a front end that lies in said blockable passage part, and a spring that lies in said spring chamber and presses said piston forwardly toward an initial piston position;
an electrical switch that operates when it senses rearward movement of said piston away from said initial piston position, and that then generates an indication of flow to a driver in a vehicle cab;
said passage including a passage connecting section that has a downstream end connected to said outlet passage portion and an upstream end connected to said blockable passage part at a connect location rearward of said piston front end in the initial piston position and forward of a front end of said passage blockable part, with said connect location positioned so said piston front end lies rearward of a front end of said connect location but still in said blockable passage part when the piston is moved sufficiently rearward.

8. The control valve described in claim 7 including:
a chamber hole that connects said chamber to said outlet passage portion.

9. The control valve described in claim 8 wherein:
said chamber hole extends in a first lateral direction from said chamber to said outlet passage portion;
said housing has an empty space lying in a second lateral direction from said chamber and has a cover that covers said empty space to prevent air leakage thereat;
said passage connecting section is aligned with said empty space, to thereby facilitate drilling/boring said connecting section.
